(19) United States
(12) Patent Application Publication
(10) Pub. No.: US 2022/0384084 A1
(43) Pub. Date: Dec. 1, 2022

(54) BACK PRESSURE ADJUSTMENT FOR INDUCTOR COOLING

(71) Applicant: Ford Global Technologies, LLC, Dearborn, MI (US)

(72) Inventors: John P. Casci, Westland, MI (US); Moon Young Lee, Livonia, MI (US); Baoming Ge, Okemos, MI (US)

(73) Assignee: Ford Global Technologies, LLC, Dearborn, MI (US)

(21) Appl. No.: 17/333,242

(22) Filed: May 28, 2021

(51) Int. Cl. H01F 27/10; H01F 27/24; H01F 27/32

(52) U.S. Cl. CPC H01F 27/10; H01F 27/24; H01F 27/325

(57) ABSTRACT

An inductor includes a bobbin defining a cavity, coils wound around the bobbin, and a plug inserted into the cavity. The plug and bobbin define a first fluid path between an inlet and the cavity. The plug is also arranged to choke flow of fluid through the first fluid path.

### TECHNICAL FIELD

The present disclosure relates to automotive inductor cooling.

### BACKGROUND

Automatic Transmission Fluid (ATF) is commonly used to cool different components of the transmission system. As such, balancing backpressure for each component may be necessary to deliver enough pressurized oil to each component. Different system applications, however, have different backpressure requirements for each component necessitating individual design and possible increasing design complexity and cost.

### SUMMARY

An inductor includes a core, a bobbin surrounding the core and defining a cavity, coils wound around portions of the bobbin, and a plug inserted into the cavity. The bobbin defines fluid paths between an inlet and the cavity, and the cavity and the coils. The plug is in fluid communication with the fluid paths and chokes flow of fluid between the inlet and coils through the fluid paths.

An inductor includes a bobbin defining a cavity, coils wound around the bobbin, and a plug inserted into the cavity. The plug and bobbin define a first fluid path between an inlet and the cavity. The plug chokes flow of fluid through the first fluid path.

An inductor includes a core, coils surrounding portions of the core, a plug, and a bobbin overhanging the coils and defining a cavity that houses the plug such that portions of the plug and bobbin define a first fluid path between an inlet and the cavity. The plug chokes flow of fluid through the first fluid path.

### BRIEF DESCRIPTION OF THE DRAWINGS

FIG. 1 illustrates a front view of an inductor.

FIG. 2 illustrates a back view of an inductor.

FIG. 3 illustrates a cross sectional view of an inductor having a cavity occupied by a plug.

FIG. 4 illustrates a cross sectional view of an inductor having a cavity occupied by a plug comprising one or more fins.

FIG. 5 illustrates a cross sectional view of an inductor having a cavity occupied by a plug defining a serpentine fluid path.

### DETAILED DESCRIPTION

The disclosed embodiments are merely examples and other embodiments can take various and alternative forms. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

As used in the specification and the appended claims, the singular form “a,” “an,” and “the” comprise plural references unless the context clearly indicates otherwise. For example, reference to a component in the singular is intended to comprise a plurality of components.

The term “substantially” or “about” may be used herein to describe disclosed or claimed embodiments. The term “substantially” or “about” may modify a value or relative characteristic disclosed or claimed in the present disclosure. In such instances, “substantially” or “about” may signify that the value or relative characteristic it modifies is within ±0%, 0.1%, 0.5%, 1%, 2%, 3%, 4%, 5% or 10% of the value or relative characteristic.

Vehicles that use a traction motor drive (electric machine or electric motor) for propulsion are referred to as electric vehicles (EVs). There are three main classes of electric vehicles. These three classes, which are defined by the extent of their electricity consumption, are namely Battery Electric Vehicles (BEV), Hybrid Electric Vehicles (HEV), and Plug-In Hybrid Electric Vehicles (PHEV). Battery electric vehicles generally use an external electrical grid to recharge their internal battery and power their electric motors. Hybrid electric vehicles use a main internal combustion engine and a secondary supplemental battery to power their motors. Plug-in hybrid electric vehicles, in contrast to hybrid electric vehicles, use a main large capacity battery and a secondary internal combustion engine to power their motors. Some plug-in hybrid electric vehicles can also run solely on their internal combustion engine without engaging the motors.

Electric vehicles typically include a voltage converter between the battery and the motor. Electric vehicles that entertain AC electrical current typically also include an inverter. Voltage converters may increase (boost) or decrease (buck) the voltage potential for enhancing performance of a traction motor drive. Voltage converters are normally comprised of a power inductor (reactor), diodes, and switches. The power inductor may comprise a conductive coil wounded around a magnetic core, which may be made from iron. The core may also be magnetized. Furthermore, one or more bobbin structures may be disposed between portions of the coil winding and the core.

The voltage converter and the inverter may be configured to deliver electrical power to the electric vehicle. This delivery of electrical power often results in heat generation which in turn necessitates a cooling system. Inductor cooling is commonly accomplished by mounting the inductor on a heat sink plate of an inverter system controller's aluminum housing, splashing fluid (typically transmission fluid) that acts as coolant onto the surface of the inductor, or flowing coolant in a conduit adjacent to the inductor. Accordingly, inductors may be cooled either actively or passively from the outside or the exterior of the inductor assembly. These methods, however, suffer from certain drawbacks.

Splashing transmission fluid onto the inductor via the internal gears within the transmission, for example, may not provide sufficient cooling as it is largely dependent on the vehicle speed. More specifically, high vehicle speed results in a high rotational speed of gears which in turn will be splashing the transmission fluid onto the inductor. However, under low vehicle speeds, where the gears within the transmission will be splashing the transmission fluid at a low rotational speed, the transmission fluid may not reach the inductor or a reduced amount of transmission fluid may reach the inductor, resulting in a reduction in the cooling of the inductor. Similarly, in other cooling methods, the transmission fluid may not have enough pressure to effectively cool down the inductor as it flows through a conduit adjacent to the inductor.

A solution to such a problem may include spraying pressurized transmission fluid from a nozzle onto targeted cooling surfaces of the inductor. The inlet or outlet of the inductor nozzle design can be modified to tune the back pressure to support different system applications. This method, however, may substantially increase the number of parts, complexity, and costs because it necessitates individual design for each component of the transmission system as each part may have a different backpressure requirement. Accordingly, there is a need to adjust back pressure, based on each system application, without having to substantially increase the number of parts, complexity, and costs.

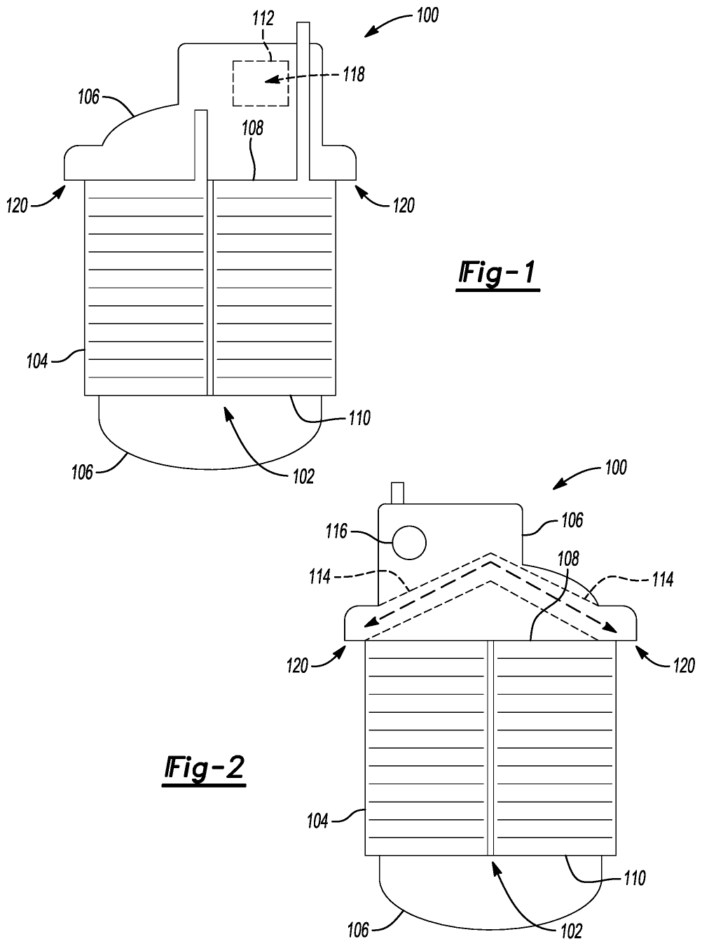

Referring to FIGS. 1-2, an inductor 100 for a voltage converter is illustrated. FIG. 1 illustrates a front view of the inductor 100 while FIG. 2 illustrates a back view of the inductor 100. The inductor 100 includes a core 102, which may be made from iron. The core 102 may also be magnetized. The inductor 100 also includes a coil or coil winding 104 that is disposed about the core 102. One or more bobbin structures 106 may be disposed around portions of the coil winding 104 and the core 102 surrounding the same. The one or more bobbin structures 106 may be disposed over a first end 108, a second end 110, or both ends of the inductor 100. Alternatively, the one or more bobbin structures 106 may be a part of the core 102 of the inductor 100. In such embodiments, the coil or coil winding 104 may be wound around portions of the bobbin 106.

In some embodiments, the one or more bobbin structures 106 may define a cavity 112 (not shown in FIG. 2). Furthermore, the bobbin 106 may define at least one fluid path 114 (not shown in FIG. 1) between an oil inlet 116 (not shown in FIG. 1) and the cavity 112. Similarly, the bobbin 106 may define at least one fluid path 114 (not shown in FIG. 1) between the cavity 112 and the coils 104. In some embodiments, the bobbin 106 may define both fluid paths 114 between the oil inlet 116 and the cavity 112 and the cavity 112 and the coils 104. In some embodiments, portions of the core 102 may form at least a part of the fluid paths 114 defined by the one or more bobbins 106. In other words, the fluid paths 114 may be at least partially defined by the core 102. For example, portions of the core 102 may form at least one side of the fluid paths 114 defined by the one or more bobbins 106.

A plug 118 (not shown in FIG. 2) may be inserted into the cavity 112 such that the plug 118 is in fluid communication with the fluid paths 114 and is configured to choke flow of fluid between the inlet 116 and coils 104 through the fluid paths 114. Automatic Transmission Fluid (ATF) may be delivered to the inductor 100 via the fluid paths 114 for purposes of cooling the inductor 100. In some embodiments, a pump (not shown) is configured to deliver ATF to the inductor 100. More specifically, the pump, or any other means of oil delivery, may force ATF into the fluid paths 114 to cool the inductor 100 before exiting the fluid paths 114 via one or more oil outlets 120. The one or more oil outlets 120 may be situated in the overhanging portion of the bobbin 106 such that they overhang the coil winding 104.

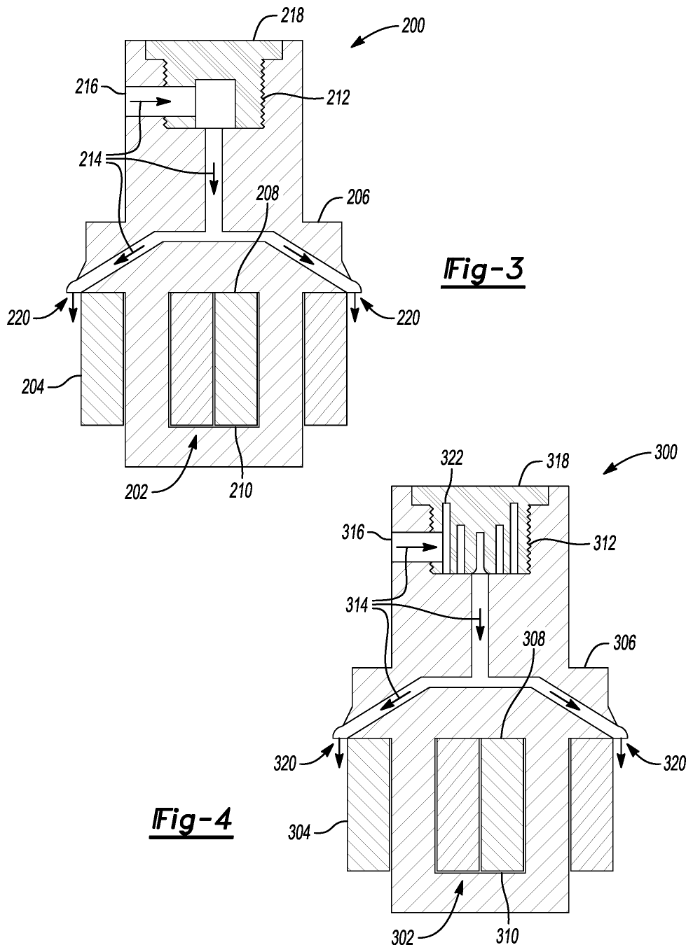

FIG. 3 illustrates a cross sectional view of an inductor 200. In particular, this exaggerated figure shows the flow direction of the ATF in some embodiments for the purpose of cooling down the inductor 200. The inductor 200 shown in this figure comprises a core 202 and a coil or coil winding 204 that may be disposed around the core 202. The inductor 200 may further comprise one or more bobbin structures 206 which may be disposed around portions of the coil windings 204 and the core 202 surrounding the same. The one or more bobbin structures 206 may be disposed over a first end 208, a second end 210, or both ends of the inductor 200. Alternatively, the one or more bobbin structures 206 may be a part of the core 202 of the inductor 200. In such embodiments, the coil or coil winding 204 may be wound around portions of the bobbin 206. In some embodiments, the one or more bobbin structures 206 may define a cavity 212, at least one fluid path 214 between an oil inlet 216 and the cavity 212, and at least one fluid path 214 between the cavity 212 and the coils 204. In some embodiments, the bobbin 206 may define both fluid paths 214 between an oil inlet 216 and the cavity 212, and the cavity 212 and the coils 204. In some embodiments, portions of the core 202 may form at least a part of the fluid paths 214 defined by the one or more bobbins 206. In other words, the fluid paths 214 may be at least partially defined by the core 202. For example, portions of the core 202 may form at least one side of the fluid paths 214 defined by the one or more bobbins 206.

Inductor 200 may further comprise a plug 218 configured to form a seal upon insertion into the cavity 212 such that the plug 218 is in fluid communication with the fluid paths 214 and is configured to choke flow of fluid between the inlet 216 and coils 204 through the fluid paths 214. Automatic Transmission Fluid (ATF) may be delivered to the inductor 200 via the fluid paths 214 for purposes of cooling the inductor 200. In some embodiments, a pump (not shown), or any other means of oil delivery, may force ATF into the fluid paths 214 to cool the inductor 200 before subsequently exiting the fluid paths 214 via one or more oil outlets 220. The one or more oil outlets 220 may be situated in the overhanging portions of the bobbin 206 such that they overhang the coil winding 204. FIG. 3 demonstrated that the ATF may be fed to the inductor 200 via the oil inlet 216 where it travels through the at least one fluid path 214 between the oil inlet 216 and the cavity 212, occupied by the plug 218 before traveling to the at least one fluid path 214 between the cavity 212 and the coils 204. The fluid path 214 between the cavity 212 and the coils 204 may facilitate the cooling of the inductor 200 by causing the ATF to flow adjacent to the coils before and/or after the ATF exits the fluid path 214 via the one or more outlets 220 which may be situated in the overhanging portions of the bobbin 206.

As mentioned above, depending on their application, different components of a transmission system have different backpressure requirements which may necessitate individual design to ensure delivery of enough pressurized oil to each component. The plug of the subject application is a mechanism that may be used to achieve the desired back pressure without substantially increasing cost, complexity, or number of parts. For example, the proposed plug may define a plurality of fins that obstruct the flow of fluid through the plug. These fins may have different shapes, dimensions, or configurations. In some embodiments, for example, the fins may have a tined configuration.

FIG. 4 illustrates a cross sectional view of an inductor 300. The inductor 300 shown in this figure comprises a core 302 and a coil or coil winding 304 that may be disposed around the core 302. The inductor 300 may further comprise one or more bobbin structures 306 which may be disposed around portions of the coil windings 304 and the core 302 surrounding the same. The one or more bobbin structures 306 may be disposed over a first end 308, a second end 310, or both ends of the inductor 300. Alternatively, the one or more bobbin structures 306 may be a part of the core 302 of the inductor 300. In such embodiments, the coil or coil winding 304 may be wound around portions of the bobbin 306. In some embodiments, the one or more bobbin structures 306 may define a cavity 312, at least one fluid path 314 between an oil inlet 316 and the cavity 312, and at least one fluid path 314 between the cavity 312 and the coils 304. In some embodiments, the bobbin 306 may define both fluid paths 314 between an oil inlet 316 and the cavity 312 and the cavity 312 and the coils 304. In some embodiments, portions of the core 302 may form at least a part of the fluid paths 314 defined by the one or more bobbins 306. In other words, the fluid paths 314 may be at least partially defined by the core 302. For example, portions of the core 302 may form at least one side of the fluid paths 314 defined by the one or more bobbin 306.

Inductor 300 may further comprise a plug 318 configured to form a seal upon insertion into the cavity 312 such that the plug 318 is in fluid communication with the fluid paths 314 and is configured to choke flow of fluid between the inlet 316 and coils 304 through the fluid paths 314. Automatic Transmission Fluid (ATF) may be delivered to the inductor 300 via the fluid paths 314 for purposes of cooling the inductor 300. In some embodiments, a pump (not shown), or any other means of oil delivery, may force ATF into the fluid paths 314 to cool the inductor 300 before subsequently exiting the fluid paths 314 via one or more oil outlets 320. The one or more oil outlets 320 may be situated in the overhanging portions of the bobbin 306 such that they overhang the coil winding 304. FIG. 4 demonstrated that the ATF may be fed to the inductor 300 via the oil inlet 316 where it travels through the at least one fluid path 314 between the oil inlet 316 and the cavity 312, occupied by the plug 318 before traveling to the at least one fluid path 314 between the cavity 312 and the coils 304. The fluid path 314 between the cavity 312 and the coils 304 may facilitate the cooling of the inductor 300 by causing the ATF to flow adjacent to the coils before and/or after the ATF exits the fluid path 314 via the one or more outlets 320 which may be situated in the overhanging portions of the bobbin 306.

The plug 318 may further define a plurality of fins 322 that obstruct the flow of fluid. The fins 322 of the plug 318 may have different shapes, dimensions, or configurations. In the embodiment shown in FIG. 4, for example, the fins 322 of the plug 318, have different dimensions (length and thickness). In some embodiments, the fins 322 may have different lengths but the same thickness. In other embodiments, the fins 322 may have the same length but different thicknesses. In yet other embodiments, the fins 322 may have different lengths and thicknesses or the same lengths and thickness. Similarly, the fins 322 of the plug 318 may assume the same or different shapes. For example, in some embodiments, the fins 322 may be cylindrical, cubical, tined, or a combination thereof. The fins 322 of the plug 318 may also have different configurations. In some embodiments, for example, alternating ones of the fins 322 extend from opposite sides of the plug 318 toward an axial center thereof to define a tortuous path for the flow of fluid through the plug 318. In other embodiments, the plug 318 further comprises a cap (not shown) wherein the fins 322 extend from the cap toward the fluid path 314 between the cavity 312 and the coils 304. In some embodiments, the cap may be flush with an outer surface of the bobbin 306.

Fins defined by the plug are not the only means of choking fluid flow to meet different design requirements—i.e., provide a sufficiently pressurized oil to different components of the transmission system to aid heat dissipation. In some embodiments, the plug may define a gap having a width less than a width of the fluid path between the cavity and coils. In other embodiments, the plug may define a serpentine fluid path wherein different parts of the serpentine fluid path have different lengths/widths. In yet other embodiments, the plug may define a bow or a cone shaped path to take advantage of the corresponding fluid mechanics principles that influence back pressure such as sudden expansion.

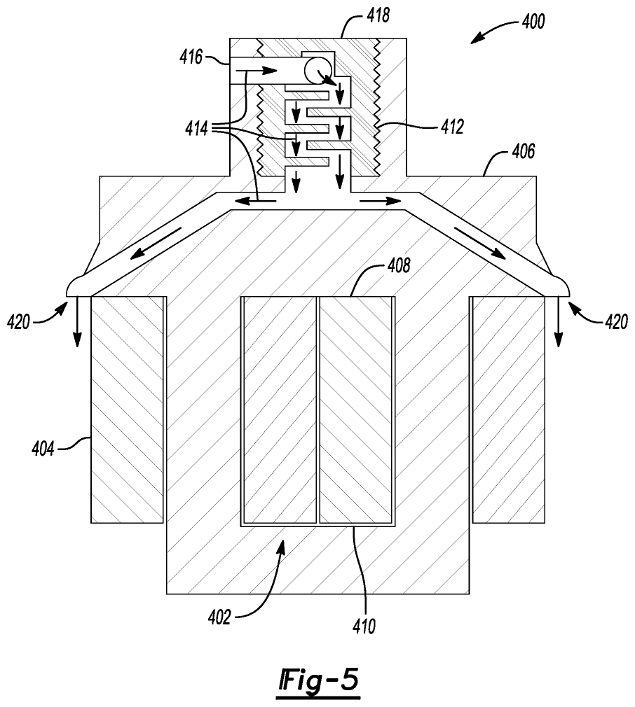

FIG. 5 illustrates a cross sectional view of an inductor 400. The inductor 400 shown in this figure comprises a core 402 and a coil or coil winding 404 that may be disposed around the core 402. The inductor 400 may further comprise one or more bobbin structures 406 which may be disposed around portions of the coil windings 404 and the core 402 surrounding the same. The one or more bobbin structures 406 may be disposed over a first end 408, a second end 410, or both ends of the inductor 400. Alternatively, the one or more bobbin structures 406 may be a part of the core 402 of the inductor 400. In such embodiments, the coil or coil winding 404 may be wound around portions of the bobbin 406. In some embodiments, the one or more bobbin structures 406 may define a cavity 412, at least one fluid path 414 between an oil inlet 416 and the cavity 412, and at least one fluid path 414 between the cavity 412 and the coils 404. In some embodiments, the bobbin 406 may define both fluid paths 414 between the oil inlet 416 and the cavity 412, and the cavity 412 and the coils 404. In some embodiments, portions of the core 402 may form at least a part of the fluid paths 414 defined by the one or more bobbin 406. In other words, the fluid paths 414 may be at least partially defined by the core 402. For example, portions of the core 402 may form at least one side of the fluid paths 414 defined by the one or more bobbins 406.

Inductor 400 may further comprise a plug 418 configured to form a seal upon insertion into the cavity 412 such that the plug 418 is in fluid communication with the fluid paths 414 and is configured to choke flow of fluid between the inlet 416 and coils 404 through the fluid paths 414. Automatic Transmission Fluid (ATF) may be delivered to the inductor 400 via the fluid paths 414 for purposes of cooling the inductor 400. In some embodiments, a pump (not shown), or any other means of oil delivery, may force ATF into the fluid paths 414 to cool the inductor 400 before subsequently exiting the fluid paths 414 via one or more oil outlets 420. The one or more oil outlets 420 may be situated in the overhanging portions of the bobbin 406 such that they overhang the coil winding 404. FIG. 5 demonstrated that the ATF may be fed to the inductor 400 via the oil inlet 416 where it travels through the at least one fluid path 414 between the oil inlet 416 and the cavity 412, occupied by the plug 418 before traveling to the at least one fluid path 414 between the cavity 412 and the coils 404. The fluid path 414 between the cavity 412 and the coils 404 may facilitate the cooling of the inductor 400 by causing the ATF to flow adjacent to the coils before and/or after the ATF exits the fluid path 414 via the one or more outlets 420 which may be situated in the overhanging portions of the bobbin 406.

The plug 418 may further define a serpentine fluid path 414 between the cavity 412 and the coils 404. This serpentine fluid path 414 may be used to obstruct the flow of ATF. This fluid flow obstruction may be achieved by causing the fluid to travel through a serpentine fluid path 414 wherein different parts of the path 414 have different lengths/widths.

While this disclosure discusses the plug of the subject application in the context of inductor cooling, it is to be understood that such plug can also be used in association with different components of the transmission system. Indeed, one of the advantages of the plug disclosed herein may be that it can easily be modified and replaced to meet different program needs.

While exemplary embodiments are described above, it is not intended that these embodiments describe all possible forms encompassed by the claims. The words used in the specification are words of description rather than limitation, and it is understood that various changes can be made without departing from the spirit and scope of the disclosure.

As previously described, the features of various embodiments can be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics, are not outside the scope of the disclosure and can be desirable for particular applications.

What is claimed is:

1. An inductor comprising:
a core;
a bobbin surrounding the core and defining a cavity;
coils wound around portions of the bobbin; and
a plug inserted into the cavity, wherein the bobbin defines fluid paths between (i) an inlet and the cavity and (ii) the cavity and the coils, and wherein the plug is in fluid communication with the fluid paths and is configured to choke flow of fluid between the inlet and coils through the fluid paths.

2. The inductor of claim 1, wherein the plug defines a plurality of fins that obstruct the flow of fluid through the plug.

3. The inductor of claim 2, wherein the fins have a tined configuration.

4. The inductor of claim 2, wherein the fins are of different dimensions.

5. The inductor of claim 2, wherein alternating ones of the fins extend from opposite sides of the plug toward an axial center thereof to define a tortuous path for the flow of fluid through the plug.

6. The inductor of claim 1, wherein the plug defines a gap having a width less than a width of the fluid path between the cavity and coils.

7. The inductor of claim 1, wherein the plug defines a serpentine fluid path.

8. The inductor of claim 7, wherein different portions of the serpentine fluid path have different widths or lengths.

9. The inductor of claim 2, wherein the plug includes a cap and wherein the fins extend from the cap toward the fluid path between the cavity and the coils.

10. The inductor of claim 9, wherein the cap is flush with an outer surface of the bobbin.

11. An inductor comprising:
a bobbin defining a cavity;
coils wound around the bobbin; and
a plug inserted into the cavity, wherein the plug and bobbin define a first fluid path between an inlet and the cavity and wherein the plug is configured to choke flow of fluid through the first fluid path.

12. The inductor of claim 11, wherein the bobbin defines a second fluid path between the cavity and the coils.

13. The inductor of claim 11, wherein the plug defines a plurality of fins that obstruct the flow of fluid through the first fluid path.

14. The inductor of claim 13, wherein the fins are of different dimensions.

15. The inductor of claim 11, wherein a portion of the first fluid path through the plug is serpentine.

16. An inductor comprising:
a core;
coils surrounding portions of the core;
a plug; and
a bobbin overhanging the coils and defining a cavity that houses the plug such that portions of the plug and bobbin define a first fluid path between an inlet and the cavity, and the plug chokes flow of fluid through the first fluid path.

17. The inductor of claim 16, wherein the bobbin at least partially defines a second fluid path between the cavity and the coils.

18. The inductor of claim 16, wherein the plug defines a plurality of fins that obstruct the flow of fluid therethrough.

19. The inductor of claim 18, wherein the fins are of different dimensions.

20. The inductor of claim 16, wherein at least a portion of the first fluid path is serpentine.
